(19) United States
(12) Patent Application Publication
(10) Pub. No.: US 2025/0031013 A1
(43) Pub. Date: Jan. 23, 2025

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Yang LIU, Dongguan (CN); Qianxi LU, Dongguan (CN); Cong SHI, Dongguan (CN)

(73) Assignee: GUANGDONG OPPO MOBILE TELECOMMUNICATIONS CORP., LTD., Dongguan (CN)

(21) Appl. No.: 18/908,402

(22) Filed: Oct. 7, 2024

Related U.S. Application Data
(63) Continuation of application No. PCT/CN2022/096122, filed on May 31, 2022.

(51) Int. Cl. H04W 4/02; H04W 64/00

(52) U.S. Cl. CPC H04W 4/025; H04W 64/003

(57) ABSTRACT

Embodiments of this application provide a wireless communication method and a device. The wireless communication method includes: obtaining by a terminal device, location information of M anchor devices, where the location information of the M anchor devices is used to determine location information of the terminal device; and M is a positive integer.

This application is a continuation of International Application No. PCT/CN2022/096122, filed on May 31, 2022, the disclosure of which is hereby incorporated by reference in its entirety.

### TECHNICAL FIELD

Embodiments of this application relate to the communications field, and more specifically, to a wireless communication method and a device.

### BACKGROUND

At present, in a new radio (New Radio, NR) network, a sidelink (sidelink) cannot be used to position a target terminal having a positioning requirement. Therefore, how to implement sidelink positioning is a problem that needs to be resolved.

### SUMMARY

Embodiments of this application provide a wireless communication method and a device. A terminal device or a network device may determine location information of the terminal device based on location information of M anchor devices, thereby implementing sidelink positioning

According to a first aspect, a wireless communication method is provided. The method includes:

obtaining, by a terminal device, location information of M anchor devices, where the location information of the M anchor devices is used to determine location information of the terminal device; and M is a positive integer.

According to a second aspect, a wireless communication method is provided. The method includes:
obtaining, by a network device, location information of M anchor devices,
where the location information of the M anchor devices is used to determine location information of a terminal device; and M is a positive integer.

According to a third aspect, a wireless communication method is provided. The method includes:
transmitting, by an anchor device, first information, where the first information includes location information of the anchor device; and the location information of the anchor device is used to determine location information of a terminal device.

According to a fourth aspect, a terminal device is provided, configured to execute the method in the first aspect.

Specifically, the terminal device includes a function module configured to execute the method in the first aspect.

According to a fifth aspect, a network device is provided, configured to execute the method in the second aspect.

Specifically, the network device includes a function module configured to execute the method in the second aspect.

According to a sixth aspect, an anchor device is provided, configured to execute the method in the third aspect.

Specifically, the anchor device includes a function module configured to execute the method in the third aspect.

According to a seventh aspect, a terminal device is provided, including a processor and a memory. The memory is configured to store a computer program; and the processor is configured to invoke and run the computer program stored in the memory, to cause the terminal device to execute the method in the first aspect.

According to an eighth aspect, a network device is provided, including a processor and a memory. The memory is configured to store a computer program; and the processor is configured to invoke and run the computer program stored in the memory, to cause the network device to execute the method in the second aspect.

According to a ninth aspect, an anchor device is provided, including a processor and a memory. The memory is configured to store a computer program; and the processor is configured to invoke and run the computer program stored in the memory, to cause the anchor device to execute the method in the third aspect.

According to a tenth aspect, an apparatus is provided, configured to implement the method in any one of the first aspect to the third aspect.

Specifically, the apparatus includes a processor, configured to invoke a computer program from a memory and run the computer program, to cause a device installed with the apparatus to execute the method in any one of the first aspect to the third aspect.

According to an eleventh aspect, a computer-readable storage medium is provided, configured to store a computer program. The computer program causes a computer to execute the method in any one of the first aspect to the third aspect.

According to a twelfth aspect, a computer program product is provided, including computer program instructions. The computer program instructions cause a computer to execute the method in any one of the first aspect to the third aspect.

According to a thirteenth aspect, a computer program is provided. When running on a computer, the computer program causes the computer to execute the method in any one of the first aspect to the third aspect.

### BRIEF DESCRIPTION OF DRAWINGS

FIG. 1 is a schematic diagram of a communications system architecture to which an embodiment of this application is applied.

FIG. 2 is a schematic diagram of out-of-coverage sidelink positioning according to this application.

FIG. 3 is a schematic diagram of another type of out-of-coverage sidelink positioning according to this application.

FIG. 4 is a schematic flowchart of a wireless communication method according to an embodiment of this application.

FIG. 5 is a schematic flowchart of another wireless communication method according to an embodiment of this application.

FIG. 6 is a schematic flowchart of still another wireless communication method according to an embodiment of this application.

FIG. 7 is a schematic flowchart of selecting an anchor terminal according to an embodiment of this application.

FIG. 8 to FIG. 11 are schematic flowcharts of sidelink positioning according to embodiments of this application, respectively.

FIG. 12 is a schematic block diagram of a terminal device according to an embodiment of this application.

FIG. 13 is a schematic block diagram of a network device according to an embodiment of this application.

FIG. 14 is a schematic block diagram of an anchor device according to an embodiment of this application.

FIG. 15 is a schematic block diagram of a communications device according to an embodiment of this application.

FIG. 16 is a schematic block diagram of an apparatus according to an embodiment of this application.

FIG. 17 is a schematic block diagram of a communications system according to an embodiment of this application.

### DESCRIPTION OF EMBODIMENTS

The following describes the technical solutions in embodiments of this application with reference to the accompanying drawings in the embodiments of this application. Apparently, the described embodiments are some rather than all of the embodiments of this application. For the embodiments of this application, all other embodiments obtained by a person of ordinary skill in the art without creative efforts fall within the protection scope of this application.

The technical solutions in the embodiments of this application may be applied to various communications systems, for example, a global system for mobile communication (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial network (NTN) system, a universal mobile telecommunications system (UMTS), a wireless local area network (WLAN), internet of things (IoT), wireless fidelity (WiFi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine-to-machine (M2M) communication, machine type communication (MTC), vehicle-to-vehicle (V2V) communication, sidelink (SL) communication, or vehicle-to-everything (V2X) communication. Embodiments of this application may also be applied to these communications systems.

In some embodiments, a communications system in embodiments of this application may be applied to a carrier aggregation (CA) scenario, a dual connectivity (DC) scenario, a standalone (SA) networking scenario, or a non-standalone (NSA) networking scenario.

In some embodiments, a communications system in embodiments of this application may be applied to an unlicensed spectrum, and the unlicensed spectrum may also be considered as a shared spectrum. Alternatively, a communications system in embodiments of this application may be applied to a licensed spectrum, and the licensed spectrum may also be considered as a non-shared spectrum.

In some embodiments, a communications system in embodiments of this application may be applied to an FRI frequency band (corresponding to a frequency band range 410 MHz to 7.125 GHZ), or may be applied to the FR2 frequency band (corresponding to a frequency band range 24.25 GHz to 52.6 GHz), or may be applied to a new frequency band, for example, corresponding to a frequency band range 52.6 GHz to 71 GHZ, or a high frequency band corresponding to a frequency band range 71 GHz to 114.25 GHz.

Embodiments of this application are described with reference to a network device and a terminal device. The terminal device may also be referred to as user equipment (User Equipment, UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station (ST) in a WLAN, may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, handheld, wearable, or vehicle-mounted. The terminal device may also be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self driving, a wireless terminal device in remote medical (remote medical), a wireless terminal device in smart grid, a wireless terminal device in transportation safety, a wireless terminal device in smart city, or a wireless terminal device in smart home, a vehicle-mounted communications device, a wireless communications chip/application specific integrated circuit (ASIC)/system on chip (SoC), or the like.

By way of example rather than limitation, in embodiments of this application, the terminal device may alternatively be a wearable device. The wearable device may also be referred to as a smart wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, the wearable smart device includes a full-featured and large-sized device that can implement all or some functions without relying on a smartphone, for example, a smart watch or smart glasses, and a device that only focuses on a specific type of application function and needs to cooperate with another device such as a smartphone, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional Node B (eNB or eNodeB) in LTE, or a relay station or an access point, or a vehicle-mounted device, a wearable device, a network device or a gNB (gNB) or a transmission reception point (TRP) in an NR network, or a network device in a future evolved PLMN, or a network device in an NTN, or the like.

By way of example rather than limitation, in embodiments of this application, the network device may have a mobility characteristic. For example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell (Small cell). The small cell herein may include a metro cell, a micro cell, a pico cell, a femto cell, or the like. These small cells have a characteristic of a small coverage range and low transmit power, and are applicable to providing a high-rate data transmission service.

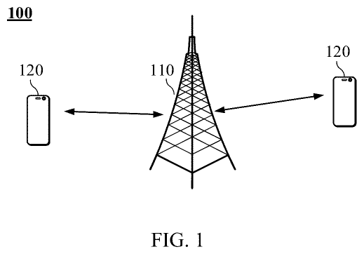

For example, a communications system 100 to which an embodiment of this application is applied is shown in FIG. 1. The communications system 100 may include a network device 110. The network device 110 may be a device that communicates with a terminal device 120 (or referred to as a communications terminal or a terminal). The network device 110 may provide communication coverage in a specific geographic area, and may communicate with a terminal device located in the coverage area.

FIG. 1 exemplarily shows one network device and two terminal devices. In some embodiments, the communications system 100 may include a plurality of network devices, and different quantities of terminal devices may be located in coverage ranges of the network devices, which is not limited in embodiments of this application.

In some embodiments, the communications system 100 may further include another network entity such as a network controller or a mobility management entity, which is not limited in embodiments of this application.

It should be understood that in embodiments of this application, a device having a communication function in a network/system may be referred to as a communications device. The communications system 100 shown in FIG. 1 is used as an example. The communications device may include the network device 110 and the terminal device 120 that have a communication function. The network device 110 and the terminal device 120 may be the foregoing specific devices, and details are not described herein again. The communications device may further include another device in the communications system 100, for example, another network entity such as a network controller or a mobility management entity, which is not limited in embodiments of this application.

It should be understood that the terms “system” and “network” in this specification may often be used interchangeably in this specification. In this specification, the term “and/or” is merely an association relationship that describes associated objects, and indicates that three relationships may exist. For example, A and/or B may represent three cases: only A exists, both A and B exist, and only B exists. In addition, the character “/” in this specification generally indicates an “or” relationship between associated objects.

It should be understood that this specification relates to a first communications device and a second communications device. The first communications device may be a terminal device, for example, a mobile phone, a machine facility, customer premise equipment (CPE), an industrial device, or a vehicle. The second communications device may be a peer communications device of the first communications device, for example, a network device, a mobile phone, an industrial device, or a vehicle. In embodiments of this application, the first communications device may be a terminal device, and the second communications device may be a network device (that is, uplink communication or downlink communication); or the first communications device may be a first terminal, and the second communications device may be a second terminal (that is, sidelink communication).

The terms used in implementations of this application are only used to illustrate specific embodiments of this application, but not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

It should be understood that, the “indication” mentioned in embodiments of this application may be a direct indication or an indirect indication, or indicate an association. For example, “A indicates B” may mean that A directly indicates B, where for example, B may be obtained by using A; may mean that A indicates B indirectly, where for example, A indicates C, and B may be obtained by using C; or may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” may be implemented in a manner in which corresponding code, a table, or other related information used for indication is pre-stored in a device (for example, including the terminal device and the network device), and a specific implementation thereof is not limited in this application. For example, being pre-defined may refer to being defined in a protocol.

In embodiments of this application, the “protocol” may refer to a standard protocol in the communications field, and may be, for example, evolution of an existing LTE protocol, an NR protocol, a Wi-Fi protocol, or a protocol related to another related communications system. A type of the protocol is not limited in this application.

To facilitate understanding of the technical solutions in embodiments of this application, the following describes the technical solutions in this application in detail by using specific embodiments. The following related technologies, as optional solutions, may be randomly combined with the technical solutions of embodiments of this application, all of which fall within the protection scope of embodiments of this application. Embodiments of this application include at least a part of the following content.

To better understand embodiments of this application, sidelink positioning related to this application is described.

As a supplement to traditional 5G positioning that relies on a terminal and a gNB (TRP), sidelink positioning additionally uses a reference signal measurement result between terminals, to complete positioning. For sidelink positioning, a reference signal should be transmitted and measured on a sidelink at a specified frequency band. A measurement result should reflect positioning reference variables having actual physical significance in space, such as a relative distance and a relative angle between terminals. After sidelink positioning is triggered, a terminal having a positioning need first needs to search for an appropriate anchor device via network allocation or by measuring a peripheral signal by itself. Then, the terminal having the positioning need measures a reference signal transmitted by the anchor device and/or the anchor device measures a reference signal transmitted by the terminal having the positioning need, to obtain a positioning measurement result and derive a positioning result.

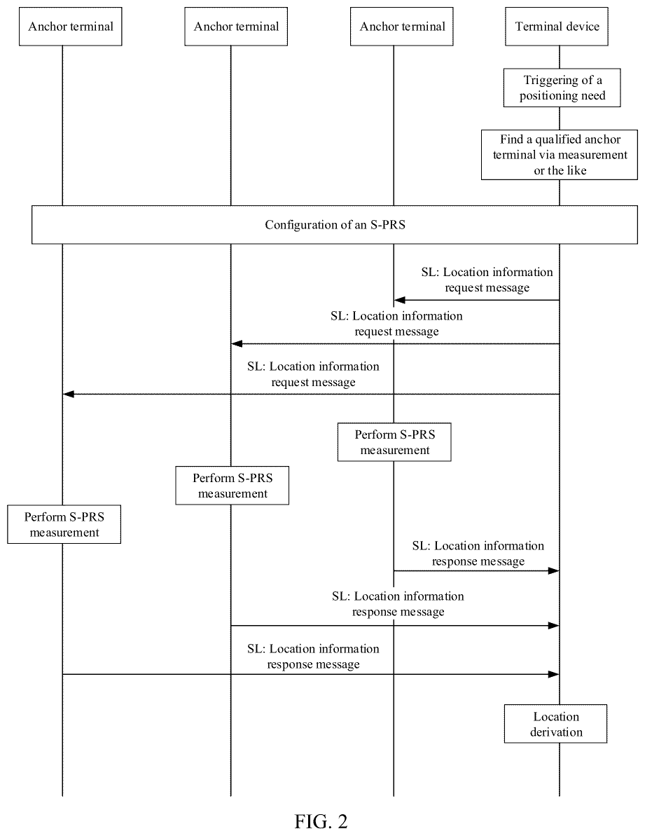

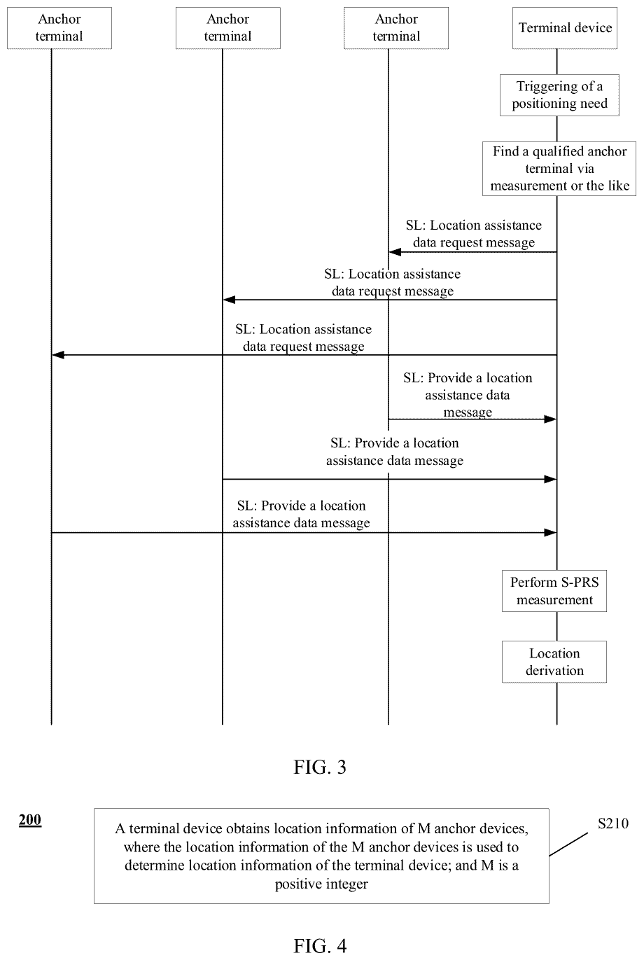

In some embodiments, sidelink positioning processes in an out-of-coverage scenario are shown in FIG. 2 and FIG. 3. FIG. 2 shows a positioning process based on a sidelink positioning reference signal transmitted by UE having a positioning need. FIG. 3 shows a positioning process based on a sidelink positioning reference signal transmitted by anchor UE.

In FIG. 2 or FIG. 3, if a terminal obtains only configuration information for a reference signal of an anchor device from signalling ProvideLocationAssistanceData, but does not obtain location information of the anchor device, the terminal cannot complete positioning.

It should be noted that, for sidelink positioning in an out-of-coverage scenario, location information of an anchor device is unknown to all components controlled by operators of a 5G network. As a result, the location information of the anchor device cannot be immediately transmitted to the terminal.

In a partial coverage positioning scenario, at least one anchor device is directly connected to the network, and another anchor device is located out of the 5G network. In this case, if a positioning operation is performed on a network side, location information of the another anchor device also needs to be transmitted to the network (routing needs to be performed via a path of the anchor device to the terminal to the anchor device directly connected to the network and to the network, or a path of the anchor device to the terminal and to the network).

In an in-coverage positioning scenario, a location of an anchor device may be transmitted by using direct signalling between the anchor device and the terminal, or may be transmitted through a route of the anchor device to the network and to the terminal, in order to assist in terminal positioning.

However, in the foregoing solutions, the location information of the anchor device cannot be obtained by the terminal or the network. As a result, sidelink positioning cannot be completed.

To resolve the foregoing problem, this application provides a sidelink positioning solution. According to the solution, a terminal device or a network device may determine location information of the terminal device based on location information of M anchor devices, thereby implementing sidelink positioning.

The following describes the technical solutions in this application in detail by using specific embodiments.

FIG. 4 is a schematic flowchart of a wireless communication method 200 according to an embodiment of this application. As shown in FIG. 4, the wireless communication method 200 may include at least part of the following content:

S210. A terminal device obtains location information of M anchor devices, where the location information of the M anchor devices is used to determine location information of the terminal device; and M is a positive integer.

In embodiments of this application, the terminal device is a terminal having a positioning need.

In embodiments of this application, the anchor device may be a device that is used for assisting in terminal positioning and may transmit a reference signal on a sidelink or measure a received reference signal on a sidelink. The anchor device and the terminal device may communicate with each other through a PC5 interface.

In embodiments of this application, “anchor device” may also be referred to as “anchor terminal” or “road side unit (RSU)” or “another terminal” or “relay terminal”. This is not limited in this application.

In some embodiments, the M anchor devices operate in an out-of-coverage scenario. Alternatively, the M anchor devices may operate in a partial coverage scenario or an in-coverage scenario.

In some embodiments, the terminal device may determine the location information of the terminal device based on the location information of the M anchor devices. Alternatively, the terminal device may report the location information of the M anchor devices to the network device, so that the network device may determine the location information of the terminal device based on the location information of the M anchor devices.

In some embodiments, the M anchor devices may be selected or determined by the terminal device. In some other embodiments, the M anchor devices may be selected or determined by the network device and indicated to the terminal device.

In some embodiments, in S210, the terminal device obtains from each of the M anchor devices location information of a respective anchor device. Specifically, for example, in a case that locations of the M anchor devices are not fixed, the terminal device obtains the location information of the M anchor devices respectively from the M anchor devices.

In some embodiments, the terminal device receives first information, where the first information includes the location information of the respective anchor device. Optionally, the first information is carried in broadcast or dedicated signalling. Therefore, it is ensured that the terminal device can obtain the location information of the anchor device at the first time. Specifically, for example, an anchor device 1 transmits the first information, where the first information includes location information of the anchor device 1.

In some embodiments, the location information included in the first information is location information transmitted periodically by the respective anchor device; or the location information included in the first information is location information transmitted once by the respective anchor device.

Specifically, for example, the location information included in the first information is location information of the respective anchor device in a past time T, where the time T is a transmission period.

In some embodiments, the first information further includes a sidelink positioning reference signal (S-PRS) measurement result of the respective anchor device.

In some embodiments, before receiving the first information, the terminal device transmits second information, where the second information is used to request an anchor device to provide location information of the anchor device. Optionally, the second information is carried in broadcast or dedicated signalling. Therefore, it is ensured that the anchor device may obtain the second information at the first time.

In some embodiments, in a case that the location information included in the first information is location information transmitted periodically by the respective anchor device, the second information includes a configuration parameter for a period.

In some embodiments, in S210, the terminal device obtains the location information of the M anchor devices from a network device. Optionally, locations of the M anchor devices are fixed. For example, the M anchor devices are road side units.

In some embodiments, the terminal device determines the location information of the terminal device based on the location information of the M anchor devices. Specifically, for example, in a mode in which a positioning result is obtained via UE-based computation, the terminal device receives the location information of the anchor device, and performs positioning.

In some embodiments, the terminal device determines the location information of the terminal device based on the location information of the M anchor devices and S-PRS measurement results of the M anchor devices.

In some embodiments, the terminal device reports third information directly; or the terminal device reports third information through another terminal device,
where the third information includes the location information of the M anchor devices.

Specifically, for example, in a mode in which a positioning result is computed based on a network, for example, a location management function (LMF) entity, the terminal device receives the location information of the anchor device and forwards the location information to a base station (through a Uu interface); or the terminal device receives the location information of the anchor device and forwards (through a sidelink) the location information to a terminal directly connected to a base station, and then the terminal transmits the location information to the base station; and finally, the base station transmits the location information to a core network network element (for example, an LMF entity).

In some embodiments, the third information further includes S-PRS measurement results of the M anchor devices.

In some embodiments, the S-PRS measurement results of the M anchor devices are respectively obtained from the M anchor devices; or the S-PRS measurement results of the M anchor devices are obtained by the terminal device via measurement.

In some embodiments, the terminal device determines the M anchor devices from a plurality of anchor devices based on location availability indication information of the plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement.

Specifically, the plurality of anchor devices may be candidate anchor devices or candidate anchor terminals. The plurality of anchor devices may be selected or determined by the terminal device; or the plurality of anchor devices may be selected or determined by the network device and indicated to the terminal device.

In some embodiments, an anchor device may evaluate credibility of location information of the anchor device; or another device (for example, the terminal device or the network device) may evaluate credibility of location information of an anchor device. For example, credibility of information about a location that is shielded by a building is lower than credibility of information about a location that is not shielded by any building; credibility of information about an indoor location is lower than credibility of information about an outdoor location; and credibility of location information obtained in a static state or a low-speed moving state is higher than credibility of location information obtained in a high-speed moving state.

In some embodiments, the terminal device determines, based on the location availability indication information of the plurality of anchor devices, an anchor device that is in the plurality of anchor devices and qualified for positioning of the terminal device; and the terminal device determines, as one of the M anchor devices, the anchor device that is qualified for positioning of the terminal device.

For example, the plurality of anchor devices include an anchor device 1, an anchor device 2, and an anchor device 3, where the location availability indication information of the anchor device 1 indicates that the anchor device 1 has location information of the anchor device 1; the location availability indication information of the anchor device 2 indicates that the anchor device 2 does not have location information of the anchor device 2; and the location availability indication information of the anchor device 3 indicates that the anchor device 3 has location information of the anchor device 3. In this case, the terminal device determines that the anchor device 1 and the anchor device 3 are qualified for positioning of the terminal device.

For another example, the plurality of anchor devices include an anchor device 1, an anchor device 2, and an anchor device 3, where the location availability indication information of the anchor device 1 indicates that the anchor device 1 has location information of the anchor device 1 and does not allow the location information of the anchor device 1 to be transferred; the location availability indication information of the anchor device 2 indicates that the anchor device 2 does not have location information of the anchor device 2; and the location availability indication information of the anchor device 3 indicates that the anchor device 3 has location information of the anchor device 3 and allows the location information of the anchor device 3 to be transferred. In this case, the terminal device determines that the anchor device 3 is qualified for positioning of the terminal device.

For still another example, the plurality of anchor devices include an anchor device 1, an anchor device 2, and an anchor device 3, where the location availability indication information of the anchor device 1 indicates that credibility of location information of the anchor device 1 is 1; the location availability indication information of the anchor device 2 indicates that credibility of location information of the anchor device 2 is 2; the location availability indication information of the anchor device 3 indicates that credibility of location information of the anchor device 3 is 3; and a higher credibility value represents lower credibility. In this case, the terminal device determines that the anchor device 1 is qualified for positioning of the terminal device; or the terminal device determines that the anchor device 1 and the anchor device 2 are qualified for positioning of the terminal device.

In some embodiments, the terminal device ranks priorities of the plurality of anchor devices based on the location availability indication information of the plurality of anchor devices; and the terminal device determines the M anchor devices based on a priority rank of the plurality of anchor devices.

For example, the plurality of anchor devices include an anchor device 1, an anchor device 2, and an anchor device 3, where the location availability indication information of the anchor device 1 indicates that the anchor device 1 has location information of the anchor device 1; the location availability indication information of the anchor device 2 indicates that the anchor device 2 does not have location information of the anchor device 2; and the location availability indication information of the anchor device 3 indicates that the anchor device 3 has location information of the anchor device 3. In this case, the priorities of the anchor device 1 and the anchor device 3 are the same; and the priorities of the anchor device 1 and the anchor device 3 are higher than the priority of the anchor device 2. The terminal device may determine that the anchor device 1 and the anchor device 3 are qualified for positioning of the terminal device.

For another example, the plurality of anchor devices include an anchor device 1, an anchor device 2, and an anchor device 3, where the location availability indication information of the anchor device 1 indicates that the anchor device 1 has location information of the anchor device 1 and does not allow the location information of the anchor device 1 to be transferred; the location availability indication information of the anchor device 2 indicates that the anchor device 2 does not have location information of the anchor device 2; and the location availability indication information of the anchor device 3 indicates that the anchor device 3 has location information of the anchor device 3 and allows the location information of the anchor device 3 to be transferred. In this case, the three anchor devices are ranked as follows in descending order of their priorities: the anchor device 3, the anchor device 1, and the anchor device 2; or the priorities of the anchor device 1 and the anchor device 2 are the same and are lower than the priority of the anchor device 3. Therefore, the terminal device determines that the anchor device 3 is qualified for positioning of the terminal device.

For still another example, the plurality of anchor devices include an anchor device 1, an anchor device 2, and an anchor device 3, where the location availability indication information of the anchor device 1 indicates that credibility of location information of the anchor device 1 is 1; the location availability indication information of the anchor device 2 indicates that credibility of location information of the anchor device 2 is 2; the location availability indication information of the anchor device 3 indicates that credibility of location information of the anchor device 3 is 3; and a higher credibility value represents lower credibility. In this case, the three anchor devices are ranked as follows in descending order of their priorities: the anchor device 1, the anchor device 2, and the anchor device 3; and the terminal device determines that the anchor device 1 is qualified for positioning of the terminal device; or the terminal device determines that the anchor device 1 and the anchor device 2 are qualified for positioning of the terminal device.

In some embodiments, the location availability indication information is transmitted by the plurality of anchor devices via broadcast or dedicated signalling. Therefore, it may be ensured that the terminal device can obtain the location availability indication information at the first time.

In some embodiments, the terminal device reports fourth information,
where the fourth information includes at least one of the following: the location availability indication information of N of the plurality of anchor devices; identifier information of an anchor device that is in the plurality of anchor devices and qualified for positioning of the terminal device; or priority rank information of the plurality of anchor devices,
where N is a positive integer; and N≥M.

It should be noted that an LMF may not know the location availability indication information, which affects location resolution of the LMF. Therefore, the terminal device may also transmit, to the LMF, location availability indication information of some anchor devices, priority rank information, or identifier information of a determined anchor device that is qualified for positioning of the terminal device. Optionally, a request transmitted by the LMF may specify to transmit location availability indication information of some anchor devices.

Optionally, the fourth information is carried in one of the following: radio resource control (RRC), uplink control information (UCI), or a media access control control element (MAC CE).

In some embodiments, before reporting the fourth information, the terminal device receives fifth information, where the fifth information is used to request for the location availability indication information. Optionally, the fifth information is further used to indicate the N anchor devices.

Optionally, the fifth information is carried in one of the following: RRC, downlink control information (DCI), or a MAC CE.

Therefore, in embodiments of this application, a positioning computation unit (a terminal device and/or a network device) may determine location information of the terminal device based on location information of M anchor devices, thereby implementing sidelink positioning. Further, the positioning computation unit (the terminal device and/or the network device) may obtain the location information of the anchor devices periodically or once, to derive location information of a positioned terminal. Still further, the positioning computation unit (the terminal device and/or the network device) may also rank priorities of the anchor devices or determine whether an anchor device is applicable to positioning, based on location availability indication information transmitted by the anchor devices.

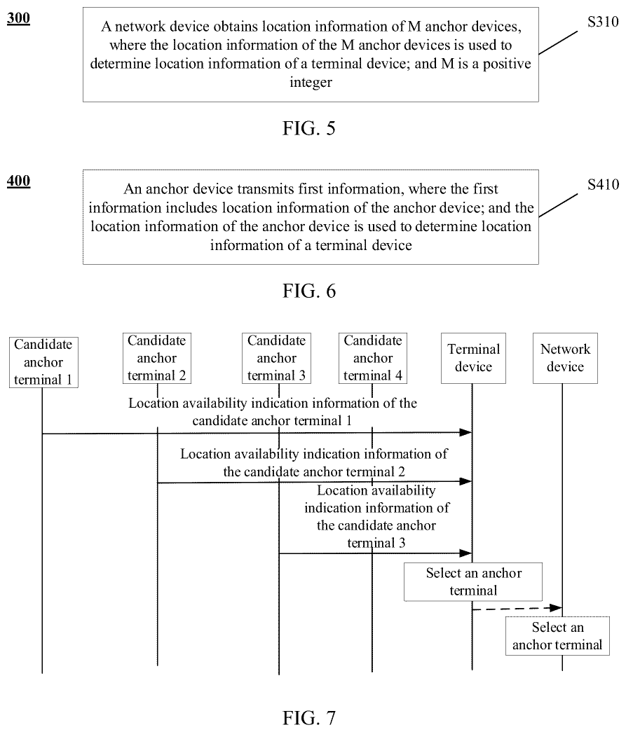

The foregoing describes a terminal side embodiment of this application in detail with reference to FIG. 4. The following describes a network side embodiment of this application in detail with reference to FIG. 5. It should be understood that the network side embodiment corresponds to the terminal side embodiment. For similar descriptions, refer to the terminal side embodiment.

FIG. 5 is a schematic flowchart of a wireless communication method 300 according to an embodiment of this application. As shown in FIG. 5, the wireless communication method 300 may include at least part of the following content:

S310. A network device obtains location information of M anchor devices, where the location information of the M anchor devices is used to determine location information of a terminal device; and M is a positive integer.

In embodiments of this application, the terminal device is a terminal having a positioning need.

In embodiments of this application, the anchor device may be a device that is used for assisting in terminal positioning and may transmit a reference signal on a sidelink or measure a received reference signal on a sidelink. The anchor device and the terminal device may communicate with each other through a PC5 interface.

In embodiments of this application, “anchor device” may also be referred to as “anchor terminal” or “road side unit (RSU)” or “another terminal” or “relay terminal”. This is not limited in this application.

In some embodiments, the network device includes at least one of the following: an access network device, an LMF entity, or an access and mobility management function (AMF) entity.

In some embodiments, the M anchor devices operate in an out-of-coverage scenario. Alternatively, the M anchor devices may operate in a partial coverage scenario or an in-coverage scenario.

In some embodiments, the M anchor devices may be selected or determined by the terminal device. In some other embodiments, the M anchor devices may be selected or determined by the network device and indicated to the terminal device.

In some embodiments, in S310, the network device receives third information, where the third information includes the location information of the M anchor devices. Optionally, the third information is transmitted by the terminal device directly; or the third information is transmitted by the terminal device through another terminal device.

Specifically, for example, in a mode in which a positioning result is computed based on a network, for example, an LMF entity, the terminal device receives the location information of the anchor device and forwards the location information to a base station (through a Uu interface); or the terminal device receives the location information of the anchor device and forwards (through a sidelink) the location information to a terminal directly connected to a base station, and then the terminal transmits the location information to the base station; and finally, the base station transmits the location information to a core network network element (for example, an LMF entity).

In some embodiments, the location information of the M anchor devices is respectively obtained from the M anchor devices. Optionally, locations of the M anchor devices are fixed. For example, the M anchor devices are road side units.

Specifically, for example, the anchor device transmits the location information of the anchor device periodically; or the anchor device transmits the location information of the anchor device once.

In some embodiments, the third information further includes S-PRS measurement results of the M anchor devices.

In some embodiments, the S-PRS measurement results of the M anchor devices are respectively obtained from the M anchor devices; or the S-PRS measurement results of the M anchor devices are obtained by the terminal device via measurement.

In some embodiments, in S310, the network device obtains the location information of the M anchor devices locally. Optionally, locations of the M anchor devices are fixed. For example, the M anchor devices are road side units.

In some embodiments, the network device determines the location information of the terminal device based on the location information of the M anchor devices.

In some embodiments, the network device determines the location information of the terminal device based on the location information of the M anchor devices and S-PRS measurement results of the M anchor devices.

In some embodiments, the network device determines the M anchor devices from a plurality of anchor devices based on location availability indication information of the plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement.

In some embodiments, an anchor device may evaluate credibility of location information of the anchor device; or another device (for example, the terminal device or the network device) may evaluate credibility of location information of an anchor device. For example, credibility of information about a location that is shielded by a building is lower than credibility of information about a location that is not shielded by any building; credibility of information about an indoor location is lower than credibility of information about an outdoor location; and credibility of location information obtained in a static state or a low-speed moving state is higher than credibility of location information obtained in a high-speed moving state.

In some embodiments, the network device determines, based on the location availability indication information of the plurality of anchor devices, an anchor device that is in the plurality of anchor devices and qualified for positioning of the terminal device; and the network device determines, as one of the M anchor devices, the anchor device that is qualified for positioning of the terminal device.

For example, the plurality of anchor devices include an anchor device 1, an anchor device 2, and an anchor device 3, where the location availability indication information of the anchor device 1 indicates that the anchor device 1 has location information of the anchor device 1; the location availability indication information of the anchor device 2 indicates that the anchor device 2 does not have location information of the anchor device 2; and the location availability indication information of the anchor device 3 indicates that the anchor device 3 has location information of the anchor device 3. In this case, the network device determines that the anchor device 1 and the anchor device 3 are qualified for positioning of the terminal device.

For another example, the plurality of anchor devices include an anchor device 1, an anchor device 2, and an anchor device 3, where the location availability indication information of the anchor device 1 indicates that the anchor device 1 has location information of the anchor device 1 and does not allow the location information of the anchor device 1 to be transferred; the location availability indication information of the anchor device 2 indicates that the anchor device 2 does not have location information of the anchor device 2; and the location availability indication information of the anchor device 3 indicates that the anchor device 3 has location information of the anchor device 3 and allows the location information of the anchor device 3 to be transferred. In this case, the network device determines that the anchor device 3 is qualified for positioning of the terminal device.

For still another example, the plurality of anchor devices include an anchor device 1, an anchor device 2, and an anchor device 3, where the location availability indication information of the anchor device 1 indicates that credibility of location information of the anchor device 1 is 1; the location availability indication information of the anchor device 2 indicates that credibility of location information of the anchor device 2 is 2; the location availability indication information of the anchor device 3 indicates that credibility of location information of the anchor device 3 is 3; and a higher credibility value represents lower credibility. In this case, the network device determines that the anchor device 1 is qualified for positioning of the terminal device; or the network device determines that the anchor device 1 and the anchor device 2 are qualified for positioning of the terminal device.

In some embodiments, the network device ranks priorities of the plurality of anchor devices based on the location availability indication information of the plurality of anchor devices; and the network device determines the M anchor devices based on a priority rank of the plurality of anchor devices.

For example, the plurality of anchor devices include an anchor device 1, an anchor device 2, and an anchor device 3, where the location availability indication information of the anchor device 1 indicates that the anchor device 1 has location information of the anchor device 1; the location availability indication information of the anchor device 2 indicates that the anchor device 2 does not have location information of the anchor device 2; and the location availability indication information of the anchor device 3 indicates that the anchor device 3 has location information of the anchor device 3. In this case, the priorities of the anchor device 1 and the anchor device 3 are the same; and the priorities of the anchor device 1 and the anchor device 3 are higher than the priority of the anchor device 2. The network device may determine that the anchor device 1 and the anchor device 3 are qualified for positioning of the terminal device.

For another example, the plurality of anchor devices include an anchor device 1, an anchor device 2, and an anchor device 3, where the location availability indication information of the anchor device 1 indicates that the anchor device 1 has location information of the anchor device 1 and does not allow the location information of the anchor device 1 to be transferred; the location availability indication information of the anchor device 2 indicates that the anchor device 2 does not have location information of the anchor device 2; and the location availability indication information of the anchor device 3 indicates that the anchor device 3 has location information of the anchor device 3 and allows the location information of the anchor device 3 to be transferred. In this case, the three anchor devices are ranked as follows in descending order of their priorities: the anchor device 3, the anchor device 1, and the anchor device 2; or the priorities of the anchor device 1 and the anchor device 2 are the same and are lower than the priority of the anchor device 3. Therefore, the network device determines that the anchor device 3 is qualified for positioning of the terminal device.

For still another example, the plurality of anchor devices include an anchor device 1, an anchor device 2, and an anchor device 3, where the location availability indication information of the anchor device 1 indicates that credibility of location information of the anchor device 1 is 1; the location availability indication information of the anchor device 2 indicates that credibility of location information of the anchor device 2 is 2; the location availability indication information of the anchor device 3 indicates that credibility of location information of the anchor device 3 is 3; and a higher credibility value represents lower credibility. In this case, the three anchor devices are ranked as follows in descending order of their priorities: the anchor device 1, the anchor device 2, and the anchor device 3; and the network device determines that the anchor device 1 is qualified for positioning of the terminal device; or the network device determines that the anchor device 1 and the anchor device 2 are qualified for positioning of the terminal device.

In some embodiments, the location availability indication information of the plurality of anchor devices is transmitted by the terminal device directly; or the location availability indication information of the plurality of anchor devices is transmitted by the terminal device through another terminal device; or the location availability indication information of the plurality of anchor devices is respectively transmitted by the anchor devices.

In some embodiments, the network device receives fourth information; and the network device determines the M anchor devices based on the fourth information,
where the fourth information includes at least one of the following: location availability indication information of N of a plurality of anchor devices; identifier information of an anchor device that is in a plurality of anchor devices and qualified for positioning of the terminal device; or priority rank information of a plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement; and
N is a positive integer; and N≥M.

It should be noted that an LMF may not know the location availability indication information, which affects location resolution of the LMF. Therefore, the terminal device may also transmit, to the LMF, location availability indication information of some anchor devices, priority rank information, or identifier information of a determined anchor device that is qualified for positioning of the terminal device. Optionally, a request transmitted by the LMF may specify to transmit location availability indication information of some anchor devices.

Optionally, the fourth information is carried in one of the following: RRC, UCI, or a MAC CE.

In some embodiments, before receiving the fourth information, the network device transmits fifth information, where the fifth information is used to request for the location availability indication information. Optionally, the fifth information is further used to indicate the N anchor devices.

Optionally, the fifth information is carried in one of the following: RRC, DCI, or a MAC CE.

Therefore, in embodiments of this application, a positioning computation unit (a terminal device and/or a network device) may determine location information of the terminal device based on location information of M anchor devices, thereby implementing sidelink positioning. Further, the positioning computation unit (the terminal device and/or the network device) may obtain the location information of the anchor devices periodically or once, to derive location information of a positioned terminal. Still further, the positioning computation unit (the terminal device and/or the network device) may also rank priorities of the anchor devices or determine whether an anchor device is applicable to positioning, based on location availability indication information transmitted by the anchor devices.

The foregoing describes a terminal side embodiment of this application in detail with reference to FIG. 4. The following describes an anchor side embodiment of this application in detail with reference to FIG. 6. It should be understood that the anchor side embodiment corresponds to the terminal side embodiment. For similar descriptions, refer to the terminal side embodiment.

FIG. 6 is a schematic flowchart of a wireless communication method 400 according to an embodiment of this application. As shown in FIG. 6, the wireless communication method 400 may include at least a part of the following content.

S410. An anchor device transmits first information, where the first information includes location information of the anchor device; and the location information of the anchor device is used to determine location information of a terminal device.

In embodiments of this application, the terminal device is a terminal having a positioning need.

In embodiments of this application, the anchor device may be a device that is used for assisting in terminal positioning and may transmit a reference signal on a sidelink or measure a received reference signal on a sidelink. The anchor device and the terminal device may communicate with each other through a PC5 interface.

In embodiments of this application, “anchor device” may also be referred to as “anchor terminal” or “road side unit (RSU)” or “another terminal” or “relay terminal”. This is not limited in this application.

Specifically, for example, the anchor device transmits the first information to the terminal device; or the anchor device transmits the first information to a network device.

In some embodiments, the anchor device operates in an out-of-coverage scenario. Alternatively, the M anchor devices may operate in a partial coverage scenario or an in-coverage scenario.

In some embodiments, the terminal device may determine the location information of the terminal device based on the location information of the M anchor devices. Alternatively, the terminal device may report the location information of the M anchor devices to the network device, so that the network device may determine the location information of the terminal device based on the location information of the M anchor devices.

In some embodiments, the location information included in the first information is location information transmitted periodically by the anchor device; or the location information included in the first information is location information transmitted once by the anchor device.

Specifically, for example, the anchor device transmits the location information of the anchor device periodically; or the anchor device transmits the location information of the anchor device once.

In some embodiments, the first information further includes an S-PRS measurement result of the anchor device.

In some embodiments, the first information is carried in broadcast or dedicated signalling. Therefore, it is ensured that the terminal device can obtain the first information at the first time.

In some embodiments, before transmitting the first information, the anchor device receives second information, where the second information is used to request the anchor device to provide the location information of the anchor device. For example, the anchor device receives the second information transmitted by the terminal device; or the anchor device receives the second information transmitted by the network device.

In some embodiments, in a case that the location information included in the first information is location information transmitted periodically by the anchor device, the second information includes a configuration parameter for a period.

In some embodiments, the second information is carried in broadcast or dedicated signalling.

In some embodiments, the anchor device transmits location availability indication information,
where the location availability indication information is used to indicate at least one of the following: whether the anchor device is aware of the location information of the anchor device; whether the anchor device allows the location information of the anchor device to be transmitted; credibility of the location information of the anchor device; or whether the location information of the anchor device meets a positioning integrity requirement.

In some embodiments, the location availability indication information is used to determine whether the anchor device is qualified for positioning of the terminal device; or the location availability indication information is used to determine priority information of the anchor device.

In some embodiments, the location availability indication information is carried in broadcast or dedicated signalling.

Therefore, in embodiments of this application, a positioning computation unit (a terminal device and/or a network device) may determine location information of the terminal device based on location information of M anchor devices, thereby implementing sidelink positioning. Further, the positioning computation unit (the terminal device and/or the network device) may obtain the location information of the anchor devices periodically or once, to derive location information of a positioned terminal. Still further, the positioning computation unit (the terminal device and/or the network device) may also rank priorities of the anchor devices or determine whether an anchor device is applicable to positioning, based on location availability indication information transmitted by the anchor devices.

The following describes technical solutions of this application in detail by using Embodiment 1 to Embodiment 5.

Embodiment 1: As shown in FIG. 7, a terminal device receives location availability indication information of a plurality of candidate anchor terminals (namely, a candidate anchor terminal 1, a candidate anchor terminal 2, and a candidate anchor terminal 3 in FIG. 7). Specifically, the terminal device selects, based on the location availability indication information of the plurality of candidate anchor terminals, an anchor terminal used for positioning of the terminal device. Alternatively, the terminal device ranks priorities of the plurality of candidate anchor terminals based on the location availability indication information of the plurality of candidate anchor terminals, and selects, based on priority rank information, an anchor terminal used for positioning of the terminal device. In this way, the terminal device completes selection of the anchor terminal.

Alternatively, in Embodiment 1, a terminal device receives location availability indication information of a plurality of candidate anchor terminals (namely, a candidate anchor terminal 1, a candidate anchor terminal 2, and a candidate anchor terminal 3 in FIG. 7); and the terminal device reports the location availability indication information of the plurality of candidate anchor terminals. Specifically, a network device selects, based on the location availability indication information of the plurality of candidate anchor terminals, an anchor terminal used for positioning of the terminal device. Alternatively, a network device ranks priorities of the plurality of candidate anchor terminals based on the location availability indication information of the plurality of candidate anchor terminals, and selects, based on priority rank information, an anchor terminal used for positioning of the terminal device. In this way, the network device completes selection of the anchor terminal.

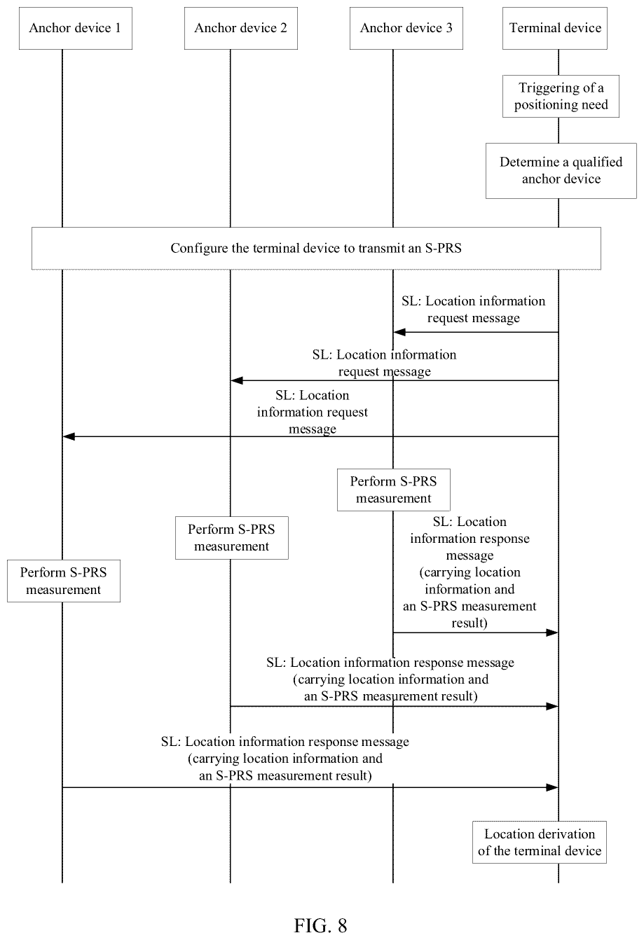

In Embodiment 2, a terminal device determines M anchor devices used for positioning (in the figure, M=3). For a specific determining manner, refer to the solution in Embodiment 1. The M anchor devices perform S-PRS measurement and obtain S-PRS measurement results. The terminal device obtains location information and a S-PRS measurement result from each of the M anchor devices; and the terminal device performs location derivation based on the location information and the S-PRS measurement results of the M anchor devices, to determine location information of the terminal device. A specific process may be as shown in FIG. 8.

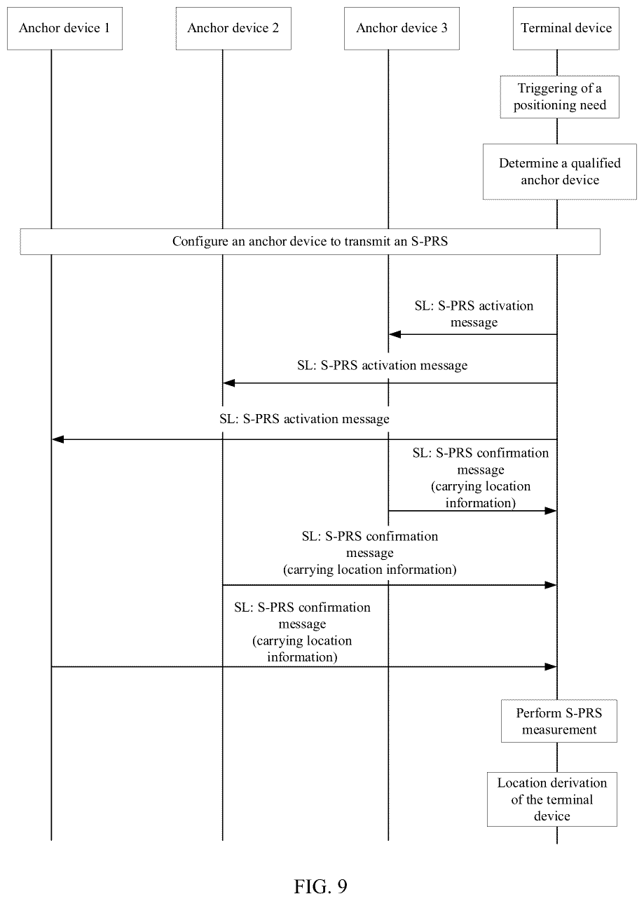

In Embodiment 3, a terminal device determines M anchor devices used for positioning (in the figure, M=3). For a specific determining manner, refer to the solution in Embodiment 1. The terminal device obtains location information from each of the M anchor devices; the terminal device performs S-PRS measurement to obtain S-PRS measurement results corresponding to the M anchor devices; and the terminal device performs location derivation based on the location information and the S-PRS measurement results of the M anchor devices, to determine location information of the terminal device. A specific process may be as shown in FIG. 9.

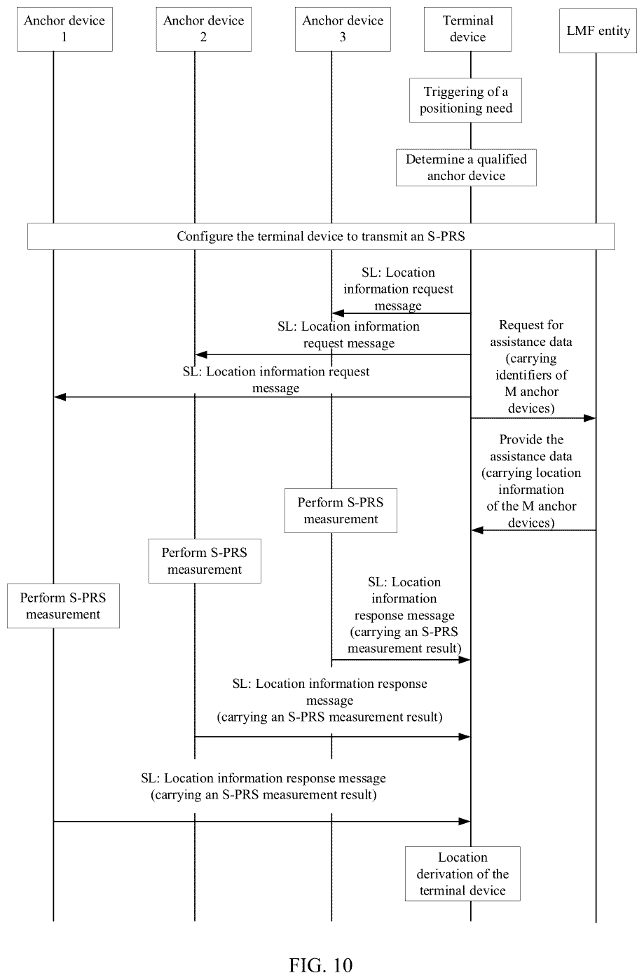

In Embodiment 4, a terminal device determines M anchor devices used for positioning (in the figure, M=3). For a specific determining manner, refer to the solution in Embodiment 1. The terminal device obtains location information of the M anchor devices from an LMF entity, where the M anchor devices are anchor devices whose locations are fixed, for example, road side units. The M anchor devices perform S-PRS measurement and obtain S-PRS measurement results. The terminal device obtains the S-PRS measurement results respectively from the M anchor devices; and the terminal device performs location derivation based on the location information and the S-PRS measurement results of the M anchor devices, to determine location information of the terminal device. A specific process may be as shown in FIG. 10.

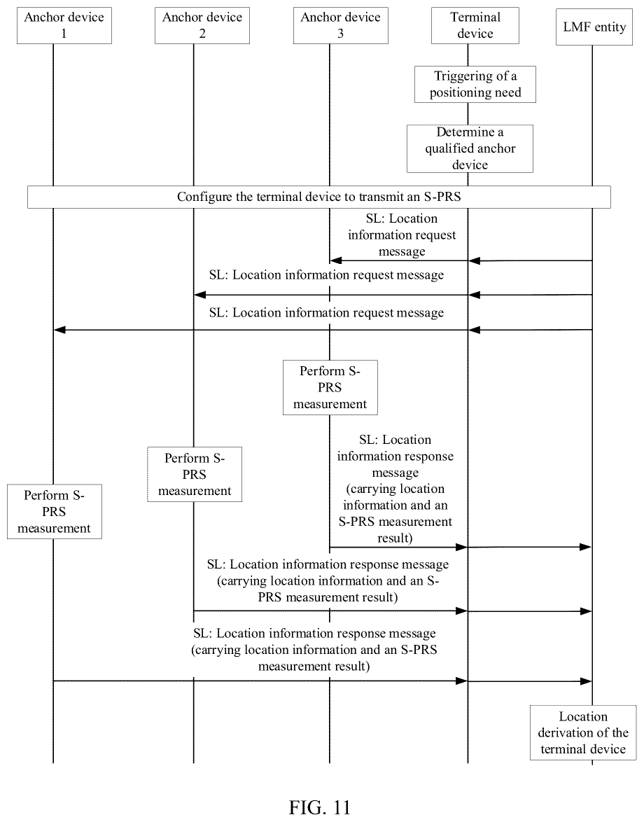

In Embodiment 5, a terminal device determines M anchor devices used for positioning (in the figure, M=3). For a specific determining manner, refer to the solution in Embodiment 1. The M anchor devices perform S-PRS measurement and obtain S-PRS measurement results. The terminal device obtains location information and the S-PRS measurement results respectively from the M anchor devices; and the terminal device reports the location information and the S-PRS measurement results of the M anchor devices to an LMF entity. In addition, the LMF entity performs location derivation based on the location information and the S-PRS measurement results of the M anchor devices, to determine location information of the terminal device. A specific process may be as shown in FIG. 11.

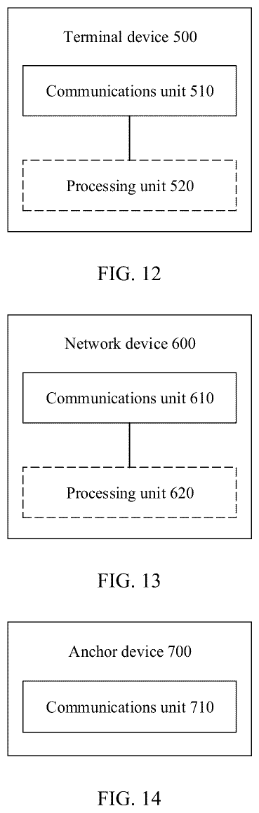

The foregoing describes method embodiments of this application in detail with reference to FIG. 4 to FIG. 11. The following describes apparatus embodiments of this application in detail with reference to FIG. 12 to FIG. 17. It should be understood that the apparatus embodiments correspond to the method embodiments. For similar descriptions, refer to the method embodiments.

FIG. 12 is a schematic block diagram of a terminal device 500 according to an embodiment of this application. As shown in FIG. 12, the terminal device 500 includes:
a communications unit 510, configured to obtain location information of M anchor devices,
where the location information of the M anchor devices is used to determine location information of the terminal device; and M is a positive integer.

In some embodiments, the communications unit 510 is specifically configured to:
obtain location information of a respective anchor device from each of the M anchor devices.

In some embodiments, the communications unit 510 is specifically configured to:
receive first information, where the first information includes the location information of the respective anchor device.

In some embodiments, the location information included in the first information is location information transmitted periodically by the respective anchor device; or the location information included in the first information is location information transmitted once by the respective anchor device.

In some embodiments, the first information further includes a sidelink positioning reference signal S-PRS measurement result of the respective anchor device.

In some embodiments, the first information is carried in broadcast or dedicated signalling.

In some embodiments, before receiving the first information, the communications unit 510 is further configured to transmit second information, where the second information is used to request an anchor device to provide location information of the anchor device.

In some embodiments, in a case that the location information included in the first information is location information transmitted periodically by the respective anchor device, the second information includes a configuration parameter for a period.

In some embodiments, the second information is carried in broadcast or dedicated signalling.

In some embodiments, the communications unit 510 is specifically configured to:
obtain the location information of the M anchor devices from a network device.

In some embodiments, locations of the M anchor devices are fixed.

In some embodiments, the terminal device 500 further includes a processing unit 520.

The processing unit 520 is configured to determine the location information of the terminal device based on the location information of the M anchor devices.

In some embodiments, the processing unit 520 is specifically configured to:
determine the location information of the terminal device based on the location information of the M anchor devices and S-PRS measurement results of the M anchor devices.

In some embodiments, the communications unit 510 is further configured to report third information directly; or the communications unit 510 is further configured to report third information through another terminal device,
where the third information includes the location information of the M anchor devices.

In some embodiments, the third information further includes S-PRS measurement results of the M anchor devices.

In some embodiments, the S-PRS measurement results of the M anchor devices are respectively obtained from the M anchor devices; or the S-PRS measurement results of the M anchor devices are obtained by the terminal device via measurement.

In some embodiments, the terminal device 500 further includes a processing unit 520.

The processing unit 520 is configured to determine the M anchor devices from a plurality of anchor devices based on location availability indication information of the plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement.

In some embodiments, the processing unit 520 is specifically configured to:
determine, based on the location availability indication information of the plurality of anchor devices, an anchor device that is in the plurality of anchor devices and qualified for positioning of the terminal device; and determine, as one of the M anchor devices, the anchor device that is qualified for positioning of the terminal device.

In some embodiments, the processing unit 520 is specifically configured to:
rank priorities of the plurality of anchor devices based on the location availability indication information of the plurality of anchor devices; and determine the M anchor devices based on a priority rank of the plurality of anchor devices.

In some embodiments, the location availability indication information is transmitted by the plurality of anchor devices via broadcast or dedicated signalling.

In some embodiments, the communications unit 510 is further configured to report fourth information,
where the fourth information includes at least one of the following: the location availability indication information of N of the plurality of anchor devices; identifier information of an anchor device that is in the plurality of anchor devices and qualified for positioning of the terminal device; or priority rank information of the plurality of anchor devices,
where N is a positive integer; and N≥M.

In some embodiments, before reporting the fourth information, the communications unit 510 is further configured to receive fifth information, where the fifth information is used to request for the location availability indication information.

In some embodiments, the fifth information is further used to indicate the N anchor devices.

In some embodiments, the M anchor devices operate in an out-of-coverage scenario.

In some embodiments, the foregoing communications unit may be a communications interface or a transceiver, or an input/output interface of a communications chip or a system on chip. The foregoing processing unit may be one or more processors.

It should be understood that the terminal device 500 according to embodiments of this application may correspond to the terminal device in the method embodiments of this application, and the foregoing and other operations and/or functions of units in the terminal device 500 are respectively used to implement corresponding processes of the terminal device in the method 200 shown in FIG. 4. For brevity, details are not described herein again. FIG. 13 is a schematic block diagram of a network device 600 according to an embodiment of this application. As shown in FIG. 13, the network device 600 includes:
a communications unit 610, configured to obtain location information of M anchor devices,
where the location information of the M anchor devices is used to determine location information of a terminal device; and M is a positive integer.

In some embodiments, the communications unit 610 is specifically configured to:
receive third information, where the third information includes the location information of the M anchor devices.

In some embodiments, the third information is transmitted by the terminal device directly; or the third information is transmitted by the terminal device through another terminal device.

In some embodiments, the location information of the M anchor devices is respectively obtained from the M anchor devices.

In some embodiments, the third information further includes sidelink positioning reference signal S-PRS measurement results of the M anchor devices.

In some embodiments, the S-PRS measurement results of the M anchor devices are respectively obtained from the M anchor devices; or the S-PRS measurement results of the M anchor devices are obtained by the terminal device via measurement.

In some embodiments, the communications unit 610 is specifically configured to:
obtain the location information of the M anchor devices locally.

In some embodiments, locations of the M anchor devices are fixed.

In some embodiments, the network device 600 further includes:
a processing unit 620, configured to determine the location information of the terminal device based on the location information of the M anchor devices.

In some embodiments, the processing unit 620 is specifically configured to:
determine the location information of the terminal device based on the location information of the M anchor devices and S-PRS measurement results of the M anchor devices.

In some embodiments, the network device 600 further includes:
a processing unit 620, configured to determine the M anchor devices from a plurality of anchor devices based on location availability indication information of the plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement.

In some embodiments, the processing unit 620 is specifically configured to:
determine, based on the location availability indication information of the plurality of anchor devices, an anchor device that is in the plurality of anchor devices and qualified for positioning of the terminal device; and determine, as one of the M anchor devices, the anchor device that is qualified for positioning of the terminal device.

In some embodiments, the processing unit 620 is specifically configured to:
rank priorities of the plurality of anchor devices based on the location availability indication information of the plurality of anchor devices; and determine the M anchor devices based on a priority rank of the plurality of anchor devices.

In some embodiments, the location availability indication information of the plurality of anchor devices is transmitted by the terminal device directly; or the location availability indication information of the plurality of anchor devices is transmitted by the terminal device through another terminal device; or the location availability indication information of the plurality of anchor devices is respectively transmitted by the anchor devices.

In some embodiments, the communications unit 610 is further configured to receive fourth information; and the processing unit 620 is further configured to determine the M anchor devices based on the fourth information,
where the fourth information includes at least one of the following: location availability indication information of N of a plurality of anchor devices; identifier information of an anchor device that is in a plurality of anchor devices and qualified for positioning of the terminal device; or priority rank information of a plurality of anchor devices,
where the location availability indication information of an anchor device among the plurality of anchor device is used to indicate at least one of the following: whether the anchor device is aware of location information of the anchor device; whether the anchor device allows location information of the anchor device to be transferred; credibility of location information of the anchor device; or whether location information of the anchor device meets a positioning integrity requirement; and
N is a positive integer; and N≥M.

In some embodiments, before receiving the fourth information, the communications unit 610 is further configured to transmit fifth information, where the fifth information is used to request for the location availability indication information.

In some embodiments, the fifth information is further used to indicate the N anchor devices.

In some embodiments, the network device includes at least one of the following: an access network device, a location management function LMF entity, or an access and mobility management function AMF entity.

In some embodiments, the M anchor devices operate in an out-of-coverage scenario.

In some embodiments, the foregoing communications unit may be a communications interface or a transceiver, or an input/output interface of a communications chip or a system on chip. The foregoing processing unit may be one or more processors.

It should be understood that the network device 600 according to embodiments of this application may correspond to the network device in the method embodiments of this application, and the foregoing and other operations and/or functions of units in the network device 600 are respectively used to implement corresponding processes of the network device in the method 300 shown in FIG. 5. For brevity, details are not described herein again.

FIG. 14 is a schematic block diagram of an anchor device 700 according to an embodiment of this application. As shown in FIG. 14, the anchor device 700 includes:
a communications unit 710, configured to transmit first information,
where the first information includes location information of the anchor device; and the location information of the anchor device is used to determine location information of a terminal device.

In some embodiments, the location information included in the first information is location information transmitted periodically by the anchor device; or the location information included in the first information is location information transmitted once by the anchor device.

In some embodiments, the first information further includes a sidelink positioning reference signal S-PRS measurement result of the anchor device.

In some embodiments, the first information is carried in broadcast or dedicated signalling.

In some embodiments, before transmitting the first information, the communications unit 710 is further configured to receive second information, where the second information is used to request the anchor device to provide the location information of the anchor device.

In some embodiments, in a case that the location information included in the first information is location information transmitted periodically by the anchor device, the second information includes a configuration parameter for a period.

In some embodiments, the second information is carried in broadcast or dedicated signalling.

In some embodiments, the communications unit 710 is further configured to transmit location availability indication information,
where the location availability indication information is used to indicate at least one of the following: whether the anchor device is aware of the location information of the anchor device; whether the anchor device allows the location information of the anchor device to be transmitted; credibility of the location information of the anchor device; or whether the location information of the anchor device meets a positioning integrity requirement.

In some embodiments, the location availability indication information is used to determine whether the anchor device is qualified for positioning of the terminal device; or the location availability indication information is used to determine priority information of the anchor device.

In some embodiments, the location availability indication information is carried in broadcast or dedicated signalling.

In some embodiments, the anchor device operates in an out-of-coverage scenario.

In some embodiments, the foregoing communications unit may be a communications interface or a transceiver, or an input/output interface of a communications chip or a system on chip. The foregoing processing unit may be one or more processors.

It should be understood that the anchor device 700 according to embodiments of this application may correspond to the anchor device in the method embodiments of this application, and the foregoing and other operations and/or functions of units in the anchor device 700 are respectively used to implement corresponding processes of the anchor device in the method 400 shown in FIG. 6. For brevity, details are not described herein again.

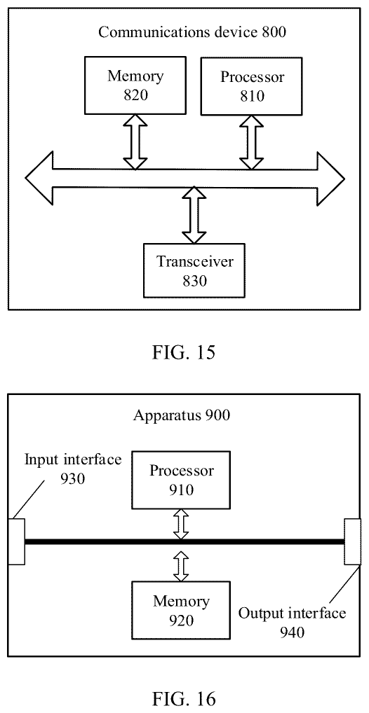

FIG. 15 is a schematic structural diagram of a communications device 800 according to an embodiment of this application. The communications device 800 shown in FIG. 15 includes a processor 810. The processor 810 may invoke a computer program from a memory and run the computer program to implement a method in embodiments of this application.

In some embodiments, as shown in FIG. 15, the communications device 800 may further include a memory 820. The processor 810 may invoke a computer program from the memory 820 and run the computer program to implement a method in embodiments of this application.

The memory 820 may be a separate component independent of the processor 810, or may be integrated into the processor 810.

In some embodiments, as shown in FIG. 15, the communications device 800 may further include a transceiver 830. The processor 810 may control the transceiver 830 to communicate with another device. Specifically, the processor 810 may transmit information or data to the another device, or receive information or data transmitted by the another device.

The transceiver 830 may include a transmitter and a receiver. The transceiver 830 may further include an antenna, and there may be one or more antennas.

In some embodiments, specifically, the communications device 800 may be the network device in embodiments of this application; and the communications device 800 may implement corresponding processes implemented by the network device in methods in the embodiments of this application. For brevity, details are not described herein again.

In some embodiments, specifically, the communications device 800 may be the terminal device in embodiments of this application; and the communications device 800 may implement corresponding processes implemented by the terminal device in methods in the embodiments of this application. For brevity, details are not described herein again.

In some embodiments, the communications device 800 may be specifically the anchor device in embodiments of this application; and the communications device 800 may implement corresponding processes implemented by the anchor device in methods in embodiments of this application. For brevity, details are not described herein again.

FIG. 16 is a schematic structural diagram of an apparatus according to an embodiment of this application. The apparatus 900 shown in FIG. 16 includes a processor 910. The processor 910 may invoke a computer program from a memory and run the computer program to implement a method in embodiments of this application.

In some embodiments, as shown in FIG. 16, the apparatus 900 may further include a memory 920. The processor 910 may invoke a computer program from the memory 920 and run the computer program to implement a method in embodiments of this application.

The memory 920 may be a separate component independent of the processor 910, or may be integrated into the processor 910.

In some embodiments, the apparatus 900 may further include an input interface 930. The processor 910 may control the input interface 930 to communicate with another device or chip, and specifically, may obtain information or data transmitted by the another device or chip.

In some embodiments, the apparatus 900 may further include an output interface 940. The processor 910 may control the output interface 940 to communicate with another device or chip, and specifically, may output information or data to the another device or chip.

In some embodiments, the apparatus may be applied to the network device in embodiments of this application; and the apparatus may implement corresponding processes implemented by the network device in methods in embodiments of this application. For brevity, details are not described herein again.

In some embodiments, the apparatus may be applied to the terminal device in embodiments of this application; and the apparatus may implement corresponding processes implemented by the terminal device in methods in the embodiments of this application. For brevity, details are not described herein again.

In some embodiments, the apparatus may be applied to the anchor device in embodiments of this application; and the apparatus may implement corresponding processes implemented by the anchor device in methods in embodiments of this application. For brevity, details are not described herein again.

In some embodiments, the apparatus mentioned in embodiments of this application may alternatively be a chip, for example, may be a system-level chip, a system chip, a chip system, a system-on-chip, or the like.

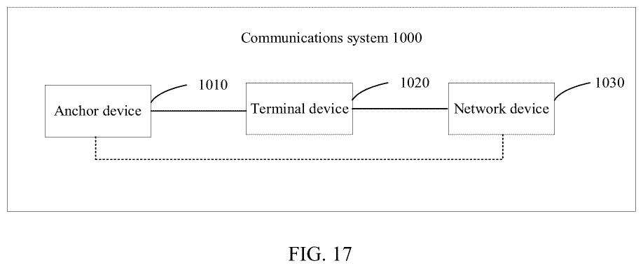

FIG. 17 is a schematic block diagram of a communications system 1000 according to an embodiment of this application. As shown in FIG. 17, the communications system 1000 includes an anchor device 1010, a terminal device 1020, and a network device 1030.

The anchor device 1010 may be configured to implement a corresponding function implemented by the anchor device in the foregoing method. The terminal device 1020 may be configured to implement a corresponding function implemented by the terminal device in the foregoing method. The network device 1030 may be configured to implement a corresponding function implemented by the network device in the foregoing method. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or execute the methods, steps, and logical block diagrams disclosed in embodiments of this application. The general-purpose processor may be a microprocessor; or the processor may be any conventional processor or the like. The steps of methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), which is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct Rambus random access memory (Direct Rambus RAM, DR RAM), or the like. In other words, the memory in embodiments of this application includes but is not limited to these memories and any memory of another proper type.

An embodiment of this application further provides a computer-readable storage medium, configured to store a computer program.

In some embodiments, the computer-readable storage medium may be applied to the network device in embodiments of this application; and the computer program causes a computer to execute corresponding processes implemented by the network device in methods in the embodiments of this application. For brevity, details are not described herein again.

In some embodiments, the computer-readable storage medium may be applied to the terminal device in embodiments of this application; and the computer program causes a computer to execute corresponding processes implemented by the terminal device in methods in the embodiments of this application. For brevity, details are not described herein again.

In some embodiments, the computer-readable storage medium may be applied to the anchor device in embodiments of this application; and the computer program causes a computer to execute corresponding processes implemented by the anchor device in methods in the embodiments of this application. For brevity, details are not described herein again.

An embodiment of this application further provides a computer program product, including computer program instructions.

In some embodiments, the computer program product may be applied to the network device in embodiments of this application; and the computer program instructions cause a computer to execute corresponding processes implemented by the network device in methods in the embodiments of this application. For brevity, details are not described herein again.

In some embodiments, the computer program product may be applied to the terminal device in embodiments of this application; and the computer program instructions cause a computer to execute corresponding processes implemented by the terminal device in methods in the embodiments of this application. For brevity, details are not described herein again.

In some embodiments, the computer program product may be applied to the anchor device in embodiments of this application; and the computer program instructions cause a computer to execute corresponding processes implemented by the anchor device in methods in the embodiments of this application. For brevity, details are not described herein again.

An embodiment of this application further provides a computer program.

In some embodiments, the computer program may be applied to the network device in embodiments of this application. When the computer program runs on a computer, the computer executes corresponding processes implemented by the network device in methods in the embodiments of this application. For brevity, details are not described herein again.

In some embodiments, the computer program may be applied to the terminal device in embodiments of this application. When the computer program runs on a computer, the computer executes corresponding processes implemented by the terminal device in methods in the embodiments of this application. For brevity, details are not described herein again.

In some embodiments, the computer program may be applied to the anchor device in embodiments of this application. When the computer program runs on a computer, the computer executes corresponding processes implemented by the anchor device in methods in the embodiments of this application. For brevity, details are not described herein again.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. Those skilled in the art may use different methods to implement the described functions for different particular applications, but it should not be considered that the implementation goes beyond the scope of this application.

Those skilled in the art may clearly understand that, for the purpose of convenient and brief description, for detailed working processes of the foregoing system, apparatus, and unit, reference may be made to a corresponding process in the foregoing method embodiments. Details are not described herein again.

In several embodiments provided in this application, it should be understood that the disclosed system, apparatus, and method may be implemented in other manners. For example, the apparatus embodiments described above are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may be or may not be physically separate. Components displayed as units may be or may not be physical units, that is, may be located in one place or distributed on a plurality of network units. Some or all of the units may be selected according to actual requirements to achieve the objectives of the solutions in embodiments.

In addition, functional units in embodiments of this application may be integrated into one processing unit, or each of the units may exist alone physically, or two or more units may be integrated into one unit.

When the functions are implemented in a form of a software functional unit and sold or used as an independent product, the functions may be stored in a computer-readable storage medium. For such understanding, the technical solutions in this application essentially, or the part contributing to the conventional technology, or some of the technical solutions may be implemented in a form of a software product. The computer software product is stored in a storage medium and includes several instructions for instructing a computer device (which may be a personal computer, a server, a network device, or the like) to perform all or some of the steps of the methods in embodiments of this application. The foregoing storage medium includes any medium that can store program code, such as a USB flash drive, a removable hard disk, a read-only memory (ROM), a random access memory (RAM), a magnetic disk, or a compact disc.

The foregoing descriptions are merely specific implementations of this application, but the protection scope of this application is not limited thereto. Any variation or replacement readily figured out by those skilled in the art within the technical scope disclosed in this application shall fall within the protection scope of this application. Therefore, the protection scope of this application should be subject to the protection scope of the claims.

What is claimed is:

1. A wireless communication method, comprising:
obtaining, by a terminal device, location information of M anchor devices,
wherein the location information of the M anchor devices is used to determine location information of the terminal device; and M is a positive integer.

2. The method according to claim 1, wherein
the obtaining, by a terminal device, location information of M anchor devices comprises:
obtaining, by the terminal device from each of the M anchor devices, location information of a respective anchor device.

3. The method according to claim 2, wherein the obtaining, by the terminal device from each of the M anchor devices, location information of a respective anchor device comprises:
receiving, by the terminal device, first information, wherein the first information comprises the location information of the respective anchor device.

4. The method according to claim 3, wherein before receiving the first information, the method further comprises:
transmitting, by the terminal device, second information, wherein the second information is used to request an anchor device to provide location information of the anchor device.

5. The method according to claim 1, wherein
the obtaining, by a terminal device, location information of M anchor devices comprises:
obtaining, by the terminal device, the location information of the M anchor devices from a network device.

6. The method according to claim 1, further comprising:
determining, by the terminal device, the location information of the terminal device based on the location information of the M anchor devices.

7. The method according to claim 6, wherein the determining, by the terminal device, the location information of the terminal device based on the location information of the M anchor devices comprises:
determining, by the terminal device, the location information of the terminal device based on the location information of the M anchor devices and sidelink positioning reference signal (S-PRS) measurement results of the M anchor devices.

8. The method according to claim 1, further comprising:
determining, by the terminal device, the M anchor devices from a plurality of anchor devices based on location availability indication information of the plurality of anchor devices,
wherein the location availability indication information of an anchor device among the plurality of anchor device is used to indicate at least one of following: whether the anchor device is aware of location information of the anchor device; whether the anchor device allows location information of the anchor device to be transferred; credibility of location information of the anchor device; or whether location information of the anchor device meets a positioning integrity requirement.

9. A terminal device, comprising:
a processor, configured to obtain location information of M anchor devices,
wherein the location information of the M anchor devices is used to determine location information of the terminal device; and M is a positive integer.

10. The terminal device according to claim 9, wherein
the processor is configured to obtain, from each of the M anchor devices, location information of a respective anchor device.

11. The terminal device according to claim 9, wherein
the processor is further configured to determine the location information of the terminal device based on the location information of the M anchor devices.

12. The terminal device according to claim 9, wherein
the processor is further configured to determine the M anchor devices from a plurality of anchor devices based on location availability indication information of the plurality of anchor devices,
wherein the location availability indication information of an anchor device among the plurality of anchor device is used to indicate at least one of following: whether the anchor device is aware of location information of the anchor device; whether the anchor device allows location information of the anchor device to be transferred; credibility of location information of the anchor device; or whether location information of the anchor device meets a positioning integrity requirement.

13. A network device, comprising:
a processor, configured to obtain location information of M anchor devices,
wherein the location information of the M anchor devices is used to determine location information of a terminal device; and M is a positive integer.

14. The network device according to claim 13, wherein
the processor is configured to receive third information, wherein the third information comprises the location information of the M anchor devices.

15. The network device according to claim 14, wherein the location information of the M anchor devices is respectively obtained from the M anchor devices.

16. The network device according to claim 14, wherein the third information further comprises sidelink positioning reference signal (S-PRS) measurement results of the M anchor devices.

17. The network device according to claim 16, wherein the S-PRS measurement results of the M anchor devices are respectively obtained from the M anchor devices; or the S-PRS measurement results of the M anchor devices are obtained by the terminal device via measurement.

18. The network device according to claim 13, wherein
the processor is configured to determine the location information of the terminal device based on the location information of the M anchor devices.

19. The network device according to claim 18, wherein
the processor is configured to determine the location information of the terminal device based on the location information of the M anchor devices and S-PRS measurement results of the M anchor devices.

20. The network device according to claim 13, wherein
the processor is configured to determine the M anchor devices from a plurality of anchor devices based on location availability indication information of the plurality of anchor devices,
wherein the location availability indication information of an anchor device among the plurality of anchor device is used to indicate at least one of following: whether the anchor device is aware of location information of the anchor device; whether the anchor device allows location information of the anchor device to be transferred; credibility of location information of the anchor device; or whether location information of the anchor device meets a positioning integrity requirement.
